(19) United States
(12) Patent Application Publication
(10) Pub. No.: US 2008/0268866 A1
(43) Pub. Date: Oct. 30, 2008

(54) Configurable telematics and location-based system

(75) Inventor: Anwar Mohamad Farid Sukkarie, Burnaby (CA)

Correspondence Address: Norman Eldridge, 215 - 4299 Canada Way, Burnaby, BC, V5G 1H3, CA

(73) Assignee: Webtech Wireless Inc.

(21) Appl. No.: 11/790,109

(22) Filed: Apr. 24, 2007

(51) Int. Cl. H04Q 7/20; G01C 21/26

(52) U.S. Cl. 455/456.1; 455/456.2; 701/207; 701/214

(57) ABSTRACT

A GSM-based wireless gateway device for facilitating of Telematics and Location-Based Services using GPS via a wireless communications network and a centralized management system. The GSM-based wireless device includes dynamically configurable Virtual SIM Card, a Telematics and Location-based Services virtual client, and event profiles which allow the wireless device to be dynamically reconfigured. The wireless device is a Telematics and Location-Based Services ASIC that will allow installation on the assembly lines of vehicle manufacturers.

### NOTICE REGARDING COPYRIGHTED MATERIAL

A portion of the disclosure of this patent document contains material which is subject to copyright protection. The copyright owner has no objection to the facsimile reproduction by anyone of the patent document or the patent disclosure as it appears in the Patent and Trademark office file or records, but otherwise reserves all copyright rights whatsoever.

### FIELD OF THE INVENTION

This invention relates to the field of Telematics and Locations Based Services (LBS).

### BACKGROUND OF THE INVENTION

Ever since the advent of ubiquitous wireless networks and GPS satellites, Telematics and LBS management systems have been deployed and specialized wireless devices have been installed in vehicles to facilitate various Telematics and locations-based services. In the art, such devices are commonly called “Telematics and LBS Locators”, referencing their basic functionality of locating and reporting a physical position of a vehicle. However, functionality of the locators is not limited to merely location tracking. The locators interface with other kinds of other devices and systems to collect information and data and to control operation of external systems. The locators are also typically capable of independent operation in an event of a network failure or hindrance to accessing Telematics and LBS management system platforms. In such situations, the locators operate according to pre-defined rules and/or store gathered information in local memory and wait for reconnection instead of immediately reporting.

The locators collect information and data from the vehicle itself using an interface with the vehicle's central process unit (CPU) and/or vehicle transducers and/or technology informing of the physical location of the vehicle. The data and information made available to the vehicle's operator or other external users via Telematics and LBS management systems, allow interactive and passive services. For instance, and when used by fleet operators, the Telematics and LBS locators can provide a wealth of useful functions such as efficient vehicle scheduling, dispatching and location management, monitoring driver behaviour and compliance with traffic rules and government regulations, fuel tax recovery, detailed time tracking, and enhanced driver services such as real-time mapping, Internet access, credit card processing, and many others.

When used by a vehicle operator, Telematics and LBS locators could enable a multitude of other Telematics and LBS functionality for location, safety and security, entertainment, and remote/local vehicle diagnostics applications.

The Telematics and LBS management system offers the platform upon which all these services are made possible. Systems as such come in a wide variety of structures and architecture. In the embodiment disclosed herein, the system involves the usage of the Internet, peripherals, a network operations centre, a GSM/GPRS/EDGE based cellular telephony network, and a GPS constellation.

The use of locators to offer a diverse set of applications generates different limiting requirements, both physical (e.g., installation, size, power consumption, processing speed, storage capacity, etc.), and operational (e.g., software functionalities for monitoring, tracking, recording, controlling, etc.).

To date, manufacturers of locators have not adequately overcome these limitations. Specifically, varying physical requirements have been usually met by designing the Telematics and LBS locators for specific vehicles (trucks, snow ploughs, etc.). As for solutions to customer requests, the challenge of varying functional requirements was met by developing custom software and firmware loads for each customer and/or application. Varying physical requirements create huge problems from an operational perspective especially with in-vehicle installation and the challenge of having to re-install a new GSM SIM card each time the vehicle ownership changes or when the need arises to switch GSM service providers. In terms of a solution, many disadvantages to customization exist such as software upgrades involving requested features sometimes for an entire fleet.

### SUMMARY OF THE INVENTION

There is provided a telematics and locations based services system for an operator of a vehicle comprising: (a) telecommunications system; (b) locator on the vehicle operating on a plurality of parameters; (c) central management system, operable by the operator, in communication with said locator through said telecommunications system wherein said locator and said central management system have cooperating means for said central management system to reconfigure said locator by changing one of said locator parameters.

There is also provided a method for an operator of a vehicle, comprising the steps of: (a) installing a locator on the vehicle operating on a plurality of parameters: (b) communicating with said locator through a telecommunications system to change one of said locator parameters; wherein one said parameter is the identity of said locator that is recognized by the telecommunications system for communications therethrough.

### BRIEF DESCRIPTION OF THE DRAWINGS

A better understanding of the present invention can be obtained when the following detailed description of the preferred embodiment is considered in conjunction with the following drawings, in which:

FIG. 1 is a high level diagram of a GSM cellular telephony wireless Telematics and LBS management system (TLMS).

FIG. 2 is a block diagram of a dynamically configurable Telematics and LBS ASIC.

FIG. 3 is a block diagram of a virtual SIM card system software module of the ASIC shown in FIG. 2.

FIG. 4 is a flowchart of the Virtual SIM card activation process.

FIG. 5 is a table listing Virtual SIM Card Configuration and Activation Data Files and Description.

FIG. 6 is a table listing Virtual SIM Card Configuration and Activation Management Tools

### DETAILED DESCRIPTION OF THE PREFERRED EMBODIMENT

For Telematics and LBS management systems (TLMS) that utilize GSM for wireless communication, a practical, cost effective, and technically and logistically superior solution is required to address Telematics and LBS locator vehicle installation challenges and incorporate efficiently functionality upgrades. Currently, Telematics and LBS locator devices are installed either on an assembly line at an automobile manufacturing facility, at a vehicle dealership, or at a customer's site. Installing a Telematics and LBS locator one vehicle at a time, at a customer's site or a vehicle dealership is cumbersome, costly, and causes considerable logistical issues. The ideal installation is obviously to install a Telematics and LBS locator in a vehicle before reaching the market. The solution must allow regular, cost effective, upgrades of functionality, and not require changes to the SIM card in case vehicle ownership changes.

Instead of a Telematics and LBS locator, what is sought is a Telematics and LBS ASIC to be installed on the assembly line of an automobile manufacturer coupled with a TLMS that enables applications one vehicle at a time as easily as a large number of vehicles concurrently.

The Telematics and LBS ASIC is an integral part of the TLMS that cannot work independently therefrom. This is not to say that the Telematics and LBS ASIC must always be in operational communication with the remainder of the TLMS—the ASIC could store data and information on local memory if it is not able to connect to that remainder.

The Telematics and LBS ASIC is installed into the vehicle on the assembly line at the vehicle manufacturing facility. The ASIC is connected to the on-board vehicle CPU and other data-collecting points in the vehicle. The information and data amassed in the ASIC is uploaded to the remainder of the TLMS for processing. Two-way communication ensues enabling a large variety of location-based, safety and security, entertainment, and diagnostics applications, both interactive and passive automotive services.

Technology disclosed in co-pending application Ser. No. 11/585,149 of the common assignee of this application, which co-pending application is incorporated by reference herein, shows some conventional features of a locator, including the use of a conventional SIM card for use with a GSM telecommunications system.

In contrast to the conventional SIM card, this invention teaches “virtual SIM card” that is integrated into each ASIC. The virtual SIM card allows the TLMS service provider to enable the GSM service provider to “lock in” a unique SIM card number pre-allotted to the GSM service provider's use. The GSM service provider is the only entity authorized to change the SIM card's unique number, typically upon request when a vehicle changes ownership or when the vehicle operator (owner) decides to switch GSM service providers. The virtual SIM card is a hardware module integrated into the ASIC with software that allows this particular functionality.

A TLMS client (software) resides on the ASIC. This client may be downloaded through a Bluetooth modem integrated as a module on the ASIC to a wireless device selected by the vehicle operator. The client allows local and Internet-based functionality. The applications and functionality allowed could be numerous. Non-limiting examples of groups of interest are: (1) Location-Based applications (call center-based, web-based service not accessible to subscriber, current location, speed, direction, time of last report, history of location, Geo-fencing, security, locating the closest and/or cheapest gasoline station in relation to the vehicle, Restaurant/Hotel Location, Point of Interest Management, Business Locators), (2) Safety and Security applications (Theft Control/Tracking, Roadside Assistance, Emergency Services, Accident Notification, Accident Analysis, Remote Unlock, Disable Starter, Parental Vehicle Tracking, Detect Excessive Speed, Perimeter Violation, Vehicle Alarm Integration), (3) Entertainment Applications (High Speed Wireless Games and interactive Passenger entertainment, Bluetooth Internet connectivity, Location-based concierge services), and (4) Diagnostics Applications (Remote diagnostics via OBDII/CANBUS, Update Vehicle Software, Failure Tracking, Remote Maintenance, Pollution Assessment and Carbon Credit management by assessing vehicle gasoline consumption and emissions then calculating carbon credits that can be traded with clean, environmentally friendly fuels from participating gasoline stations or companies). It is worthy to note that the aforementioned four groups of applications have a direct impact on the customer vehicle-related economics with a return-on-investment (ROI) consequence resulting from deploying TLMS directly through the ASIC.

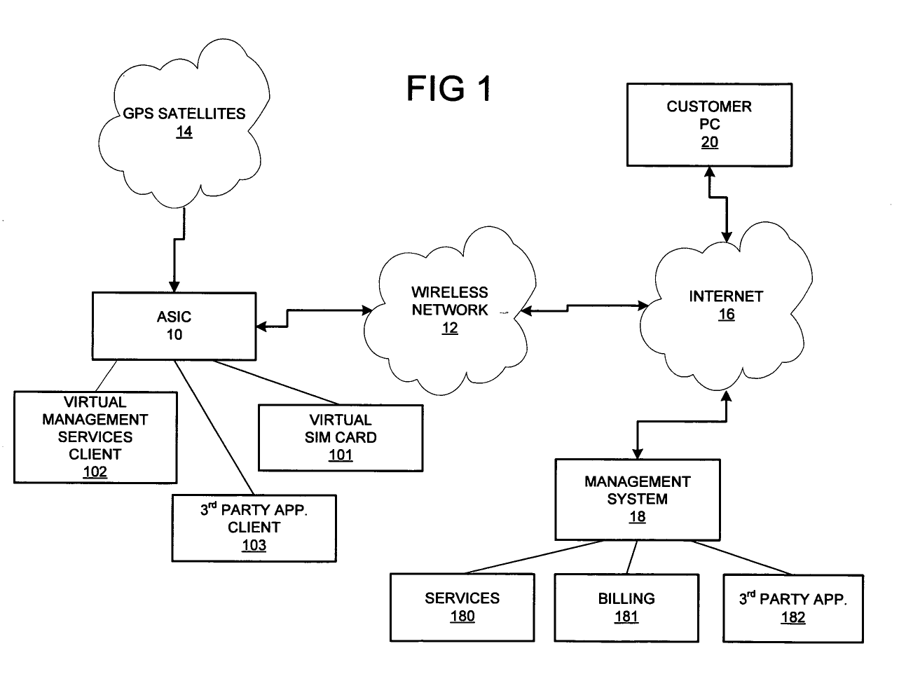

Referring to FIG. 1, a GSM-based Telematics and LBS management system (TLMS) according to one embodiment of the invention is shown. The TLMS comprises a plurality of Telematics and LBS ASICs 10 (only one shown for simplicity of illustration), each ASIC 10 having embedded Virtual SIM Card 101, embedded virtual TLMS client software 102 and embedded 3^{rd} Party Applications Clients 103; a GSM wireless network 12; a plurality of GPS satellites 14; Internet 16; a TLMS Management System 18 that includes 3^{rd} Party Applications 182, a TLMS billing system 181, and TLMS services 180; and a plurality of customer computers 20. The Telematics and Location-based Services ASIC 10 is a wireless communication chipset embedded in the vehicle (not shown) on a vehicle manufacturer's assembly line to enable Telematics and Location-based Services 180 and are offered through it. These services could be either interactive or passive. Interactive services include Navigation, Personal Digital Assistant (PDA)-based Location Services, Internet Email and Access, Utilize Panic or Emergency Button, Emergency Services, Roadside Assistance, Accident Assistance, Concierge Services such as the closest and cheapest gasoline station to the vehicle, Stolen Vehicle Tracking, Remote Horn & Lights, Remote Door Unlock, Set “Security Profile” alarm configuration, and Green Services such as fuel consumption efficiency, carbon credit calculation based on how much clean fuel was utilized versus green house gas emission levels.

In addition to standard elements known to the art, ASIC 10 contains novel elements such as the chipset form especially designed for vehicle manufacturer's assembly line installation, Virtual SIM card 101, 3^{rd} Party Applications Clients 103 and the Virtual TLMS clients 102. In one embodiment, the ASICs 10 obtain position information from the GPS satellites 14 via integrated or external GPS modems and antennas (not shown). Methods and apparatuses for obtaining GPS-based location information are well known in the art. The ASICs 10 are connected to the GSM wireless communication network 12, which may include GPRS, EDGE, and HSPSD data communication standards. The connectivity to network 12 is partly made possible through the Virtual SIM Card 101 which allows a GSM number unique to the ASIC 10 and allows data communications among other standard elements known in the art. Modes and methods of interconnection to such wireless communication networks are well known in the art and are not further described herein. TLMS is also connected to the wireless network 12 via the Internet 16. TLMS provides portal-based management functions through the ASIC 10, such as remote device configuration and upgrades, data bridging, device monitoring, tracking and reporting, to Management System subscribers.

An example of a TLMS is provided by WebTech Wireless Inc. of Burnaby, British Columbia, whose Management System is known as Quadrant Vehicle Services System™. To utilize the Telematics and LBS ASIC 10 management functions provided by TLMS, the subscribers of TLMS access TLMS 18 from PCs 20 using web browsers (not shown) or any other remote access method known in the art.

Telematics and LBS ASIC

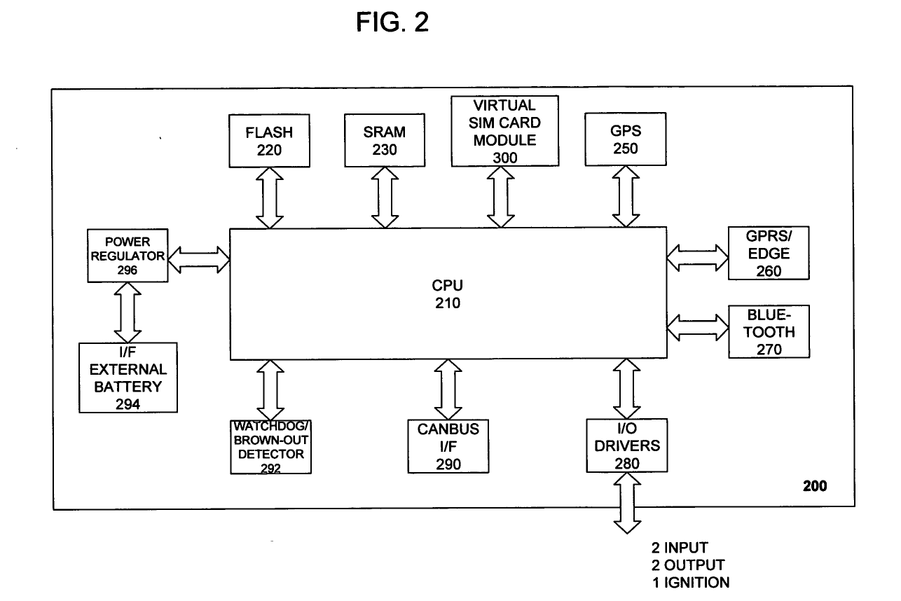

ASIC 10, rendered conceptually in FIG. 1, is shown in more functional internal detail in FIG. 2 as ASIC chipset 200. ASIC 200 comprises a microprocessor 210, I/O drivers 280 controlling connectivity and data collection from various points of interest in a vehicle, a flash memory 220 where the ASIC operating system and core applications are permanently stored, a SRAM 230 for quicker access to the applications residing on the Flash Memory 220, a Virtual SIM Card module 300 which replaces the need for the standard SIM Card used by GSM phones today and is an integral part of the ASIC 200, a GPS module 250, a GSM GPRS/EDGE module modem 260, a Bluetooth modem module 270, a CANBUS interface module 290 that allows connectivity to automotive commercial trucks and personal vehicle and collection of automotive data from central processing units available on the vehicle, a watchdog/brown-out detector with software required to minimize electric and power surge risks 292, a power regulator that connects to the vehicle's electric power system (12/24/48 VDC) 296 through the interface to External Battery module 294. Other functions of ASIC 200 (not shown in modular form) include Web server functionality.

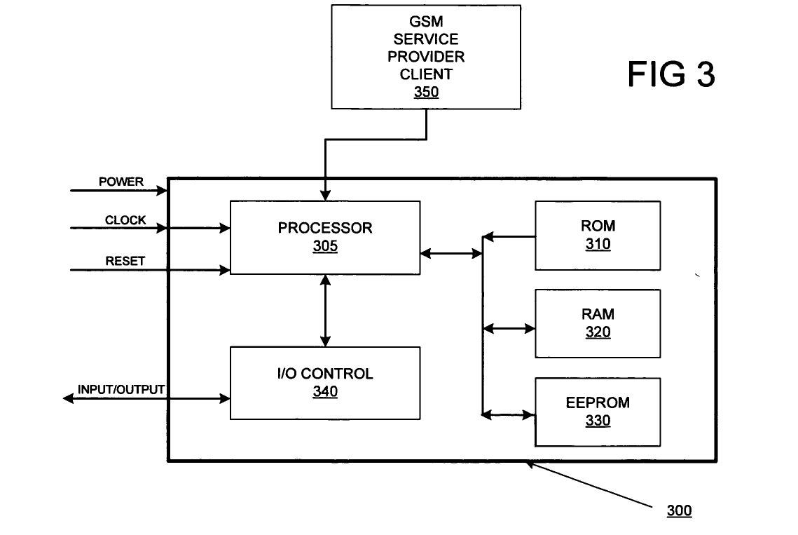

The functionality of these modules is well described in the art and are not further described with the exception of the Virtual Subscriber Identity Module (SIM) card 300 shown in FIG. 3 and the consequences thereof to the remainder of ASIC 200.

Virtual SIM Card

Referring to FIG. 3, the I/O control interface 340 enables communications between Virtual SIM card module 300 and the remainder of Telematics and LBS ASIC 200 described in FIG. 2, integrated or external.

A person skilled in the art will appreciate that the Virtual SIM Card posses the exact applications and functionality of a standard GSM SIM card with one exception. Namely, a Virtual SIM Card 300 is fully integrated with the Telematics and LBS ASIC 200 and is physically an integral, embedded, component of ASIC 200. A GSM Service Provider could activate or deactivate the Virtual SIM Card module 300 through the GSM Service Provider Client 350. ROM 310 includes all eligible GSM Service Providers authentication data. Non-volatile EEPROM 330 allows dynamic configuration of the Virtual SIM Card module 300 and software upgrades for authorized parties only, namely the GSM Service Provider and the Telematics and LBS service provider. Microprocessor 305 manages Virtual SIM Card module 300 and allows authorized parties to access the EEPROM 330 and re-assign a new phone number among other configurable authentication and identification data. The RAM 320 has standard functions that are known in the art.

Virtual SIM Card Configuration and Activation

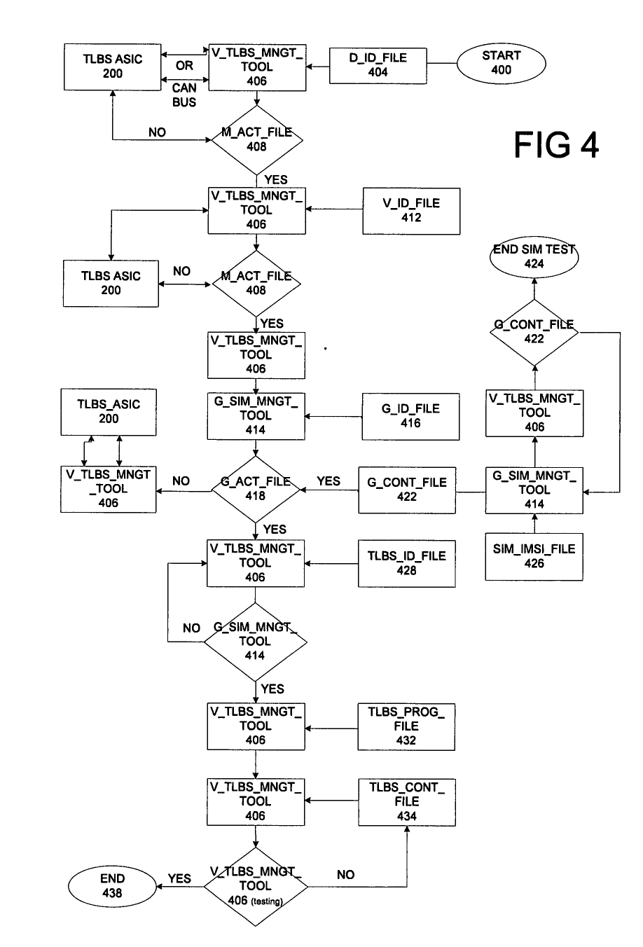

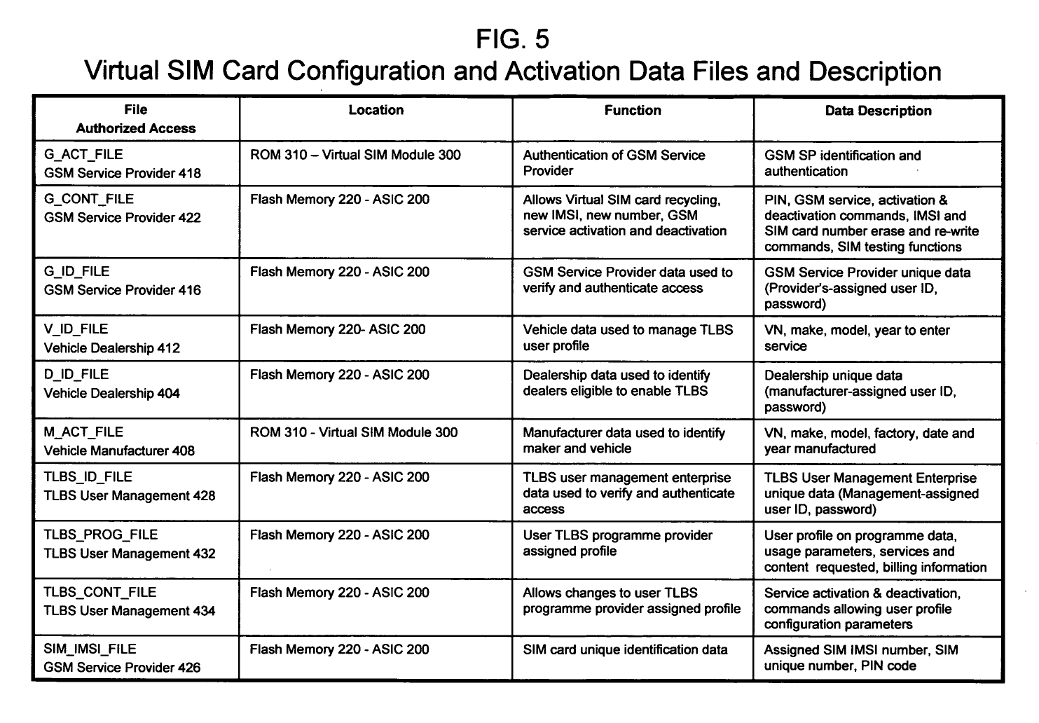

Referring to the table of FIG. 5, the data files described determine the control flowchart described in FIG. 4. herein

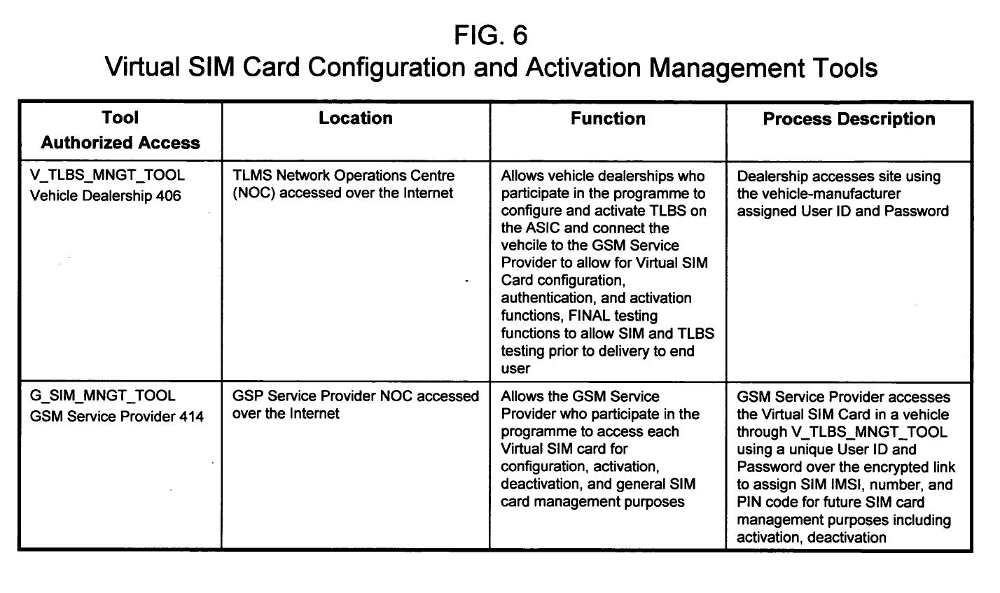

Referring to the table of FIG. 6, the test tools needed for the successful authentication, activation, and TLBS end-user delivery are described for the flowchart in FIG. 4.

Referring to FIG. 4, the process of the Virtual SIM Card configuration and activation commences at the vehicle dealership prior to delivering the new vehicle to the end-user. The start process 400 is triggered by an authorized operator on the dealership premises. Data available to the dealership in the D_ID_FILE 404 is entered into the V_TLBS_MNGT_TOOL 406 to authenticate the dealership's subscription to the TLBS programme. The V_TLBS_MNGT_TOOL 406 communicates to the TLBS ASIC 200 in the vehicle using the Bluetooth module available in the ASIC or through a hardwire connection using the CANBUS interface available in the vehicle. The data entered is compared against the manufacturer-entered data in M_ACT_FILE 408. If the data matches (namely user ID and a password) then the operator enters the vehicle specific data V_ID_FILE 412 which is checked for validity against the data in M_ACT_FILE 408. If the data matches then the V_TLBS_MNGT_TOOL 406 connects to the GSM service provider's online SIM management tool G_SIM_MNGT_TOOL 414 where an operator enters the GSM service provider's authentication data (namely user ID and password) available in the G_ID_FILE 416. The data is compared against the G_ACT_FILE 418 available on the TLBS ASIC 200. If the data matches then the GSM configuration file is entered by the GSM service provider's operator using file G_CONT_FILE 422. The GSM service provider's online SIM card management tool 414 is then used to enter the unique SIM card IMSI (well documented in the art) and SIM number using SIM_IMSI_FILE 426. The GSM service provider operator conducts a SIM Card test procedure available through the G_CONT_FILE 422 process to verify the SIM card's functionality. The TLBS configuration and activation parameters and verification is completed through TLBS_PROG_FILE 432. Final testing and delivery is completed through the V_TLBS_MNGT_TOOL 406.

If a vehicle changes ownership and the new owner wants to discontinue TLBS, then before transfer, the former owner remotely “disconnects” the Virtual SIM card. If the GSM service provider needs to be switched, the vehicle owner remotely “disconnects” the Virtual SIM card and “replaces” it with a new one of the new GSM service provider. The original GSM Service Provider should provide the PIN, UserID, Password and associated information to the new GSM service provider to allow the re-configuration of the Virtual SIM Card.

Furthermore, in addition to the parameter of “identity” as described herein, other important parameters, variables and data that define the performance of the locator, can be remotely (re)configured by Management System 18 in a way similar to that described herein for the conventional SIM card. For example, as disclosed in aforementioned co-pending application Ser. No. 11/585,149 of the common assignee of this application, reconfigurable “event profiles” of the locator are advantageously provided and can be remotely managed by Management System 18.

A preferred embodiment has been shown as a non-limiting example of the invention. This invention is not intended to be limited to the specific form set forth herein, but on the contrary, it is intended to cover such alternatives, modifications, and equivalents, as can be reasonably included within the spirit and scope of the invention as defined by the appended claims. For example, although GSM has been mentioned, other telecommunication systems are contemplated, for example, AGSM or any other telecommunication system for which the “identity” of the asset needs to be transferred (whether physically or electronically or legally) and for which remote (re)configuration would be logistically advantageous. Also, although an ASIC has been shown, other implementation technologies are contemplated, including FPGA, and the choice and mixture of implementation technologies are within the design choice of the average skilled person. What is key is this invention's recognition that the standard but discrete SIM card can be implemented in software and hardware in advantageous form that allows for remote reconfiguration of key parameters of the standard but discrete SIM card.

We claim:

1. A telematics and locations based services system for an operator of a vehicle comprising:
(a) telecommunications system;
(b) locator on the vehicle operating on a plurality of parameters;
(c) central management system, operable by the operator, in communication with said locator through said telecommunications system wherein said locator and said central management system have cooperating means for said central management system to reconfigure said locator by changing one of said locator parameters.

2. The system of claim 1, wherein one said locator parameter is a unique identity recognized by said telecommunications system to enable communications between said locator and said central management system.

3. The system of claim 2, wherein one said locator parameter is an event profile.

4. The system of claim 3, wherein said telecommunications system includes one of a public telecommunications system and a private telecommunications system.

5. The system of claim 2, wherein the functional equivalent of a GSM SIM card in said locator, is implemented in reprogrammable firmware in said locator.

6. A method for an operator of a vehicle, comprising the steps of:
(a) installing a locator on the vehicle operating on a plurality of parameters:
(b) communicating with said locator through a telecommunications system to change one of said locator parameters;
wherein one said parameter is the identity of said locator that is recognized by the telecommunications system for communications therethrough.
